(19) United States
(12) Patent Application Publication
(10) Pub. No.: US 2004/0248717 A1
(43) Pub. Date: Dec. 9, 2004

(54) Process and machine for the production of cardboard packaging boxes

(76) Inventor: Candido Calugi, Fucecchio (Firenze) (IT)

Correspondence Address: NATH & ASSOCIATES, PLLC, Sixth Floor, 1030 15th Street, N.W., Washington, DC, 20005, US

(21) Appl. No.: 10/841,523

(22) Filed: May 10, 2004

(30) Foreign Application Priority Data
Jun. 6, 2003 (IT) BO2003A000349

(51) Int. Cl. B31B 1/60

(52) U.S. Cl. 493/69; 229/198.3

(57) ABSTRACT

A process for the production of cardboard packaging boxes from cardboard blanks, comprising the following steps: preparing a stack of cardboard blanks; picking up a blank from the stack of blanks and positioning it in a folding station; folding the cardboard blank to obtain a semi-finished box; stably closing the open edges of the box by applying corner elements, the blank being T-shaped, consisting of portions of cardboard respectively corresponding to first and second opposite orthogonal faces of the box to be folded and at least one portion corresponding to at least one base of the box. The invention also relates to a machine for implementing the process and the box obtained in this way.

### BACKGROUND OF THE INVENTION

The present invention relates to the sector for the production of packaging boxes, obtained from punched cardboard blanks.

At present, with the known type of processes and machines, boxes are obtained by means of successive steps of feeding the punched blanks, folding the cardboard into a box shape and closing the open sides of the box by gluing or sealing additional elements, such as strips of paper.

Once the semi-finished box is obtained, it can be sent on for another step, of covering with a sheet of paper which may bear images or text.

In these known processes, the cardboard blanks are obtained by punching them from a sheet and are generally cross-shaped, with the opposite faces of the box joined to the corresponding sides of the base.

Starting with this configuration, once the cardboard has been folded into a box shape, the four edges of the box must be closed then the box can be covered if required.

These processes allow high productivity and normally a high level of reliability, with a limited number of rejects.

However, with the known type of processes the final cost of the box is greatly influenced by the quantity of cardboard which must be rejected after punching, because the cross shape of the blanks does not allow recovery of much of the cardboard sheet not used.

Moreover, boxes obtained in this way have all four edges open and so may have strength defects during use.

In particular, this applies to “tall” boxes of the type used to package video cassettes, books, packs of CDs, DVDs and the like, whose height and length are much greater than the width or depth of the box.

The same disadvantage is particularly evident in the case of boxes intended to hold and present luxury goods such as perfumes or jewelry, which require high quality packaging.

The aim of the present invention is, therefore, to overcome these disadvantages and to provide a process and a machine able to produce packaging boxes with minimum wastage of the cardboard used for the starting blanks, and at the same time to obtain very strong boxes with a good quality exterior.

### SUMMARY OF THE INVENTION

Accordingly, this aim is achieved by a process and machine for the production of boxes from T-shaped cardboard blanks.

According to this configuration, the starting blanks consist of two or more portions of cardboard, joined together by precreased lines.

The various portions correspond to two pairs of opposite faces and one of the bases of the box to be produced.

In particular, the central section of the T consists of two portions of cardboard corresponding to two opposite faces of the finished box, joined to two opposite sides of the base, whilst the transversal section of the T consists of the remaining two portions of cardboard, corresponding to the other two opposite faces of the box.

The invention also relates to a cardboard box made from sheets of cardboard punched in a T shape, with improved strength and exterior appearance compared with boxes of the known type.

Finally, the invention comprises a T-shaped cardboard blank for the production of packaging boxes.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a diagram of a machine for the production of packaging boxes;

FIGS. 2a-2c illustrate the succession of steps of folding a box obtained in accordance with the invention from a T-shaped cardboard blank;

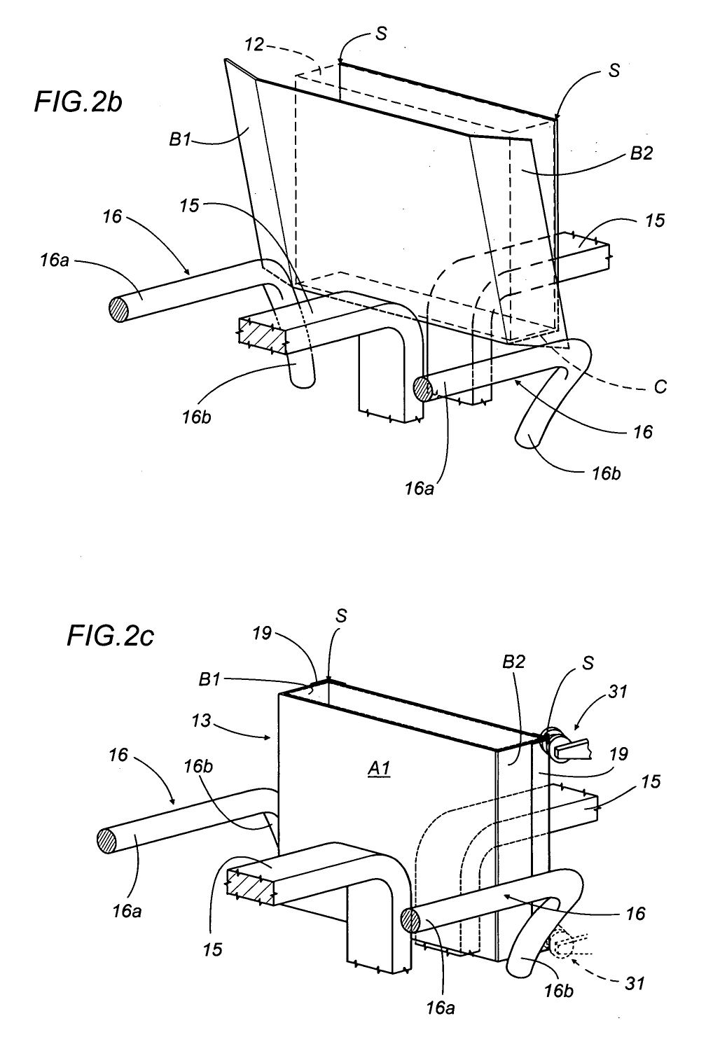

FIG. 3 is a plan view of a detail of a folding station of a machine in accordance with the present invention.

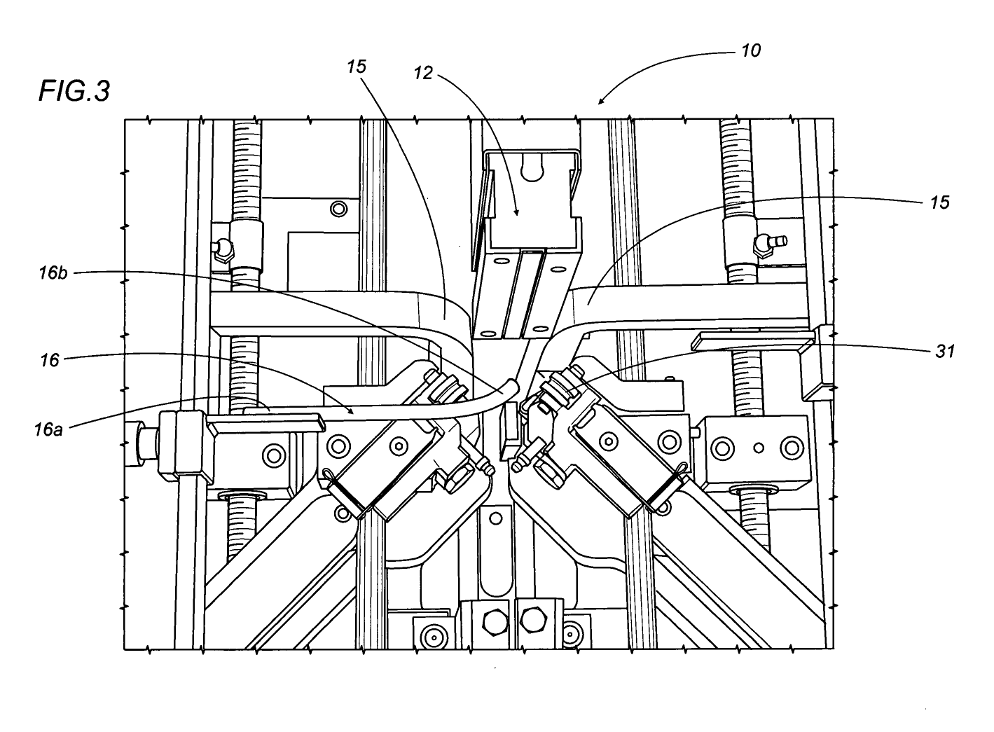

### DESCRIPTION OF THE PREFERRED EMBODIMENTS

With reference to the accompanying drawings, a process according to the invention includes the following steps:

preparing a stack of T-shaped cardboard blanks 1, each comprising portions A1, A2 and B1, B2 respectively corresponding to the opposite orthogonal faces of the box to be formed and a portion C corresponding to a box base;

picking up a blank 1 from the stack of blanks and positioning it according to the shape and size of the blank;

feeding the blank into a folding station 10;

folding the cardboard blank 1 to obtain a box 13;

stably closing the two open edges of the box 13 by application of corner elements 19, preferably heat-sealed or glued onto the semi-finished box 13.

In a preferred embodiment of the process, the step of folding the faces A1, A2 and B1, B2 of the unfinished cardboard blank 1 is carried out by moving the faces A1, A2 and B1 and B2 relative to one another and into contact with guide elements 15, 16, which fold the faces of the blank over the walls of a sample block 12 with the shape of the box to be produced.

Advantageously, in the example described the guides or contact elements 15 for folding the faces A1 and A2 are only active in the direction of relative movement, whilst the contact elements 16 for folding faces B1 and B2 are active firstly in said direction, then in the transversal direction converging towards the sample block 12, so as to complete folding of the faces B1, B2.

Once the box is obtained, there may be a step of covering it with a sheet of paper, which may bear text or decorations.

In this case, the process comprises the further steps of:

transporting the semi-finished box 13 to a covering station 20;

gluing a sheet of covering paper in a gluing machine 30;

covering the semi-finished box with the sheet of paper glued and obtaining the finished box.

According to the invention, the covering sheet may be of the conventional type, i.e.: cross-shaped, or substantially T-shaped, for a finished box with an improved finish and quality exterior.

According to another aspect of the invention, a machine for the production of cardboard boxes comprises:

means for positioning a stack of T-shaped punched cardboard blanks 1, said means being of the conventional type and so not described in further detail;

means for positioning a blank 1 in a predetermined way according to the shape and size of the blank, said means being of the conventional type and so not described in further detail;

means for picking up the blank 1 and feeding it to a folding station 10, said means being of the conventional type, for example with pick up using a suction cup, and so are not described in further detail;

means for folding the blank into the shape of a semi-finished box 13;

means 31 for applying closing corner elements 19 (e.g.: additional strips of paper) to the open edges S of the box 13. These means preferably consist of heat-sealing or gluing devices of known types and therefore not described in further detail.

Accordingly, in the embodiment illustrated the folding station comprises a sample block 12 which moves vertically relative to a supporting plane for the T-shaped cardboard blank.

In a preferred embodiment of the invention, the step of folding the cardboard blank 1 is carried out using a block 12 whose shape corresponds to that of the box to be produced and which is positioned at the base C of the box.

Then, the block 12—cardboard 1 assembly is moved vertically in a straight line towards fixed guides or contact elements 15, 16 which engage with the faces A1, A2 and B1, B2, causing the latter to be folded over the corresponding walls of the block 12.

Advantageously, the contact elements 15 and 16 are curved and are positioned at a distance from the block 12 greater than the thickness of the cardboard, so that the cardboard is not damaged during the folding stroke.

Moreover, according to the invention the contact elements 16 designed to fold the faces B1, B2 consist of a cylindrical tubular element with a first section 16a in an offset plane parallel with the corresponding wall of the block 12 and a second section 16b converging towards the wall, so that during relative movement between the faces B1, B2 and contact element 16 there is firstly guided folding in the direction of movement (simultaneously with folding of the two orthogonal faces A1, A2) and then guided folding in the transversal direction towards the wall of the block 12.

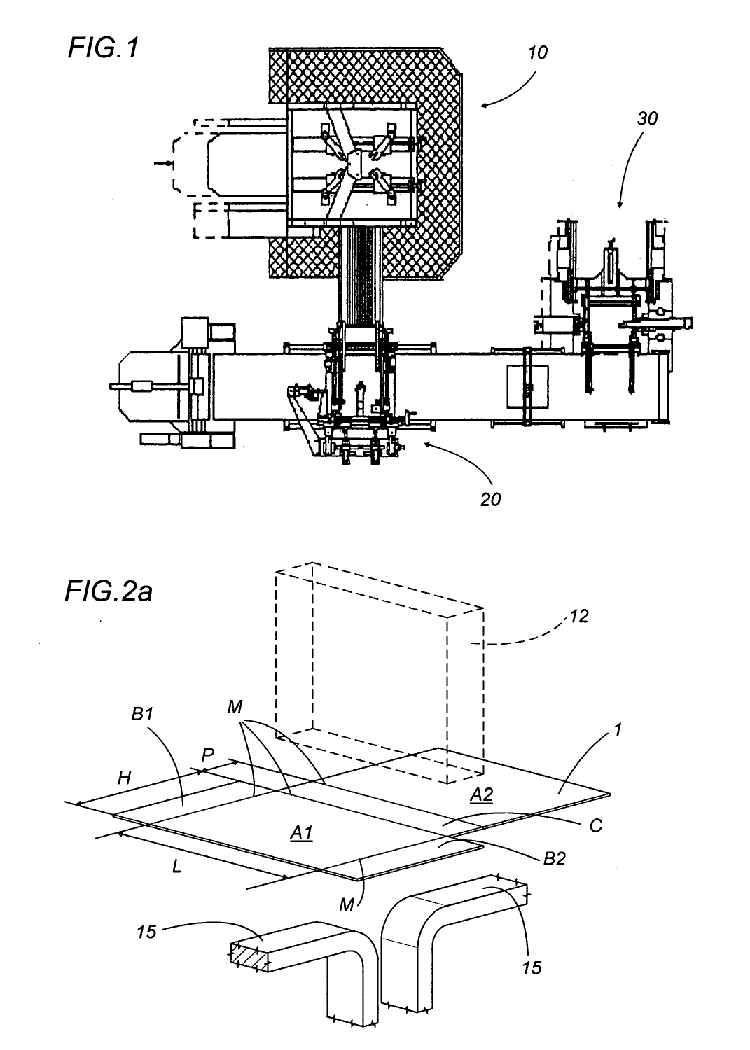

A further, covering station 20 may be used, of the known type and schematically illustrated in FIG. 1.

According to another aspect of the invention, a packaging box 13 structure is described which is obtained from a T-shaped punched cardboard blank, consisting of two pairs of opposite faces A1, A2 and B1, B2 and a base C.

In particular the two opposite faces A1, A2 of the box are joined to the two opposite sides of the base C, whilst the remaining two cardboard portions B1, B2 are joined to the two opposite free sides of the face A1.

The open vertical edges S are then joined by application of strips of heat-sealed or glued paper.

Advantageously, compared with conventional boxes which have all four vertical edges open, only two edges S on the box 13 are open and so require an additional corner element.

In this way, a stronger box structure is obtained with a better quality exterior.

Finally, the box 13 may be finished with a sheet of covering paper, which may be decorated and/or bear various types of text.

According to the invention, the covering sheet may be either of the conventional type, that is to say, cross-shaped, or substantially T-shaped.

In a preferred embodiment, the box 13 has a height H equal to 1.5-10 times, preferably 1.5-8 times the width P of the box, and a length L equal to 1.5-10 times, preferably 1.5-5 times the width P.

According to another aspect of the invention, a T-shaped punched cardboard blank for the production of packaging boxes is described.

The blank 1 consists of two or more portions of cardboard, joined by precreased lines M.

In particular, the various portions correspond to two pairs of opposite faces A1, A2 and B1, B2 and to one of the bases C of the box 13 to be produced.

In particular, the central section of the T consists of two portions of cardboard corresponding to two opposite faces A1, A2 of the finished box, joined to two opposite sides of the base C, whilst the transversal section of the T consists of the remaining two portions of cardboard B1, B2.

Advantageously, compared with the conventional cross shape, the perfect T shape of the blank 1 allows considerable savings in terms of material during the operations for punching the sheet of cardboard.

The invention described has evident industrial applications and may be subject to modifications and variations without thereby departing from the scope of the inventive concept. Moreover, all the details of the invention may be substituted by technically equivalent elements.

For example, covered by the same inventive concept, the shape of the contact elements 16 may vary and they can consist of a single element and two or more elements, without changing the function of guiding the folding of the cardboard blank in two directions.

What is claimed:

1. A process for the production of cardboard packaging boxes from cardboard blanks, comprising the following steps:
preparing a stack of cardboard blanks (1);
picking up a blank 1 from the stack of blanks and positioning it in a folding station (10);
folding the cardboard blank (1) to obtain a semi-finished box (13);
stably closing the open edges (S) of the box (13) by applying corner elements (19), wherein the blank is T-shaped, consisting of portions of cardboard (A1; A2, and B1; B2) respectively corresponding to first and second opposite orthogonal faces of the box to be folded and at least one portion (C) corresponding to at least one base of the box.

2. The process according to claim 1, wherein the step of folding the faces (A1, A2 and B1, B2) of the blank (1) is carried out by moving the faces (A1, A2 and B1 and B2) relative to contact and guide elements (15, 16) which guide the faces of the blank into contact with the corresponding walls of a sample block (12) with the shape of the box (13).

3. The process according to claim 2, wherein the guides for folding the first faces (A1 and A2) are only active in the direction of relative movement between the block (12) and the guides (15, 16), whilst the guides for folding the second faces (B1 and B2) are active in said direction and in the transversal direction converging towards the sample block (12).

4. The process according to claim 3, comprising the following steps:
transporting the semi-finished box (13) to a covering station (20);
gluing a sheet of covering paper in a gluing machine (30);
covering the semi-finished box (13) with the sheet of paper glued and obtaining the finished box.

5. The process according to claim 4, wherein the paper covering sheet is in the shape of a cross.

6. The process according to claim 4, wherein the paper covering sheet is substantially T-shaped.

7. A machine for the production of cardboard boxes from T-shaped punched blanks, comprising:
a magazine of cardboard blanks (1) for the production of boxes;
means for picking up a blank (1) from the magazine and feeding it to a folding station (10),
means for folding the blank into the shape of an open, semi-finished box (13), said folding means comprising a sample block (12) with the shape of the box to be produced and fixed contact elements or guides (15, 16) able to engage respectively with first and second orthogonal faces (A1, A2 and B1, B2) of the blank until said faces are placed over the corresponding walls of the block (12);
means (30) for stably applying closing corner elements (19) to the open edges (S) of the box (13);
wherein the contact elements (16) for folding the horizontal faces (B1, B2) consist of a first section (16a) lying in an offset plane parallel with the corresponding wall of the block (12) and a second section (16b) converging towards the wall, so that during the relative movement between the faces (B1, B2) and the contact element (16) the first guided fold is made in the direction of movement simultaneously with folding of the two orthogonal faces (A1, A2 ) then guided folding in the transversal direction towards the wall of the block (12).

8. The machine according to claim 7, wherein the contact elements (15 and 16) are curved and are positioned at a distance from the block (12) greater than the thickness of the cardboard used to make the box (13), so as not to damage the cardboard during the folding stroke.

9. The machine according to claim 7, wherein it has another, covering station (20) for the box (13).

10. The machine according to claim 7, wherein the pick up means are of the suction cup pick up type.

11. The machine according to claim 7, wherein the means for applying corner elements to the box (13) consist of heat-sealing or gluing devices.

12. A packaging box (13) made from a T-shaped punched cardboard blank, consisting of first and second opposite faces (A1, A2 and B1, B2) and of at least one base (C), the two opposite faces (A1, A2) of the box being joined to two opposite sides of the base (C), whilst the remaining two faces (B1, B2) are joined to the two free opposite sides of the face (A1).

13. The box according to claim 12, comprising two open vertical edges (S) joined by the application of strips of additional paper (19).

14. The box according to claim 12, wherein the box (13) has a paper covering sheet.

15. The box according to claim 12, wherein the paper covering sheet is substantially cross-shaped.

16. The box according to claim 12, wherein the paper covering sheet is substantially T-shaped.

17. The box according to claim 12, wherein the height (H) of the box is 1.5 to 10 times, preferably 1.5 to 8 times, its width (P) and the length (L) of the box is 1.5 to 10 times, preferably 1.5 to 5 times, its width (P).

18. A punched cardboard blank (1) for the production of packaging boxes, comprising a T-shape with two or more portions (A1, A2, B1, B2, C) joined together by precreased lines (M), the central section of the T consisting of two portions of cardboard corresponding to two opposite faces (A1, A2) of the finished box, joined to two opposite sides of the base (C), and the transversal section of the T consisting of the remaining two portions of cardboard (B1, B2).
